(19) United States
(12) Patent Application Publication
(10) Pub. No.: US 2024/0035338 A1
(43) Pub. Date: Feb. 1, 2024

(54) PNEUMATIC LIFT APPARATUS FOR LADDER

(71) Applicant: Ferrell Deen, Wapato, WA (US)

(72) Inventor: Ferrell Deen, Wapato, WA (US)

(21) Appl. No.: 17/878,524

(22) Filed: Aug. 1, 2022

(51) Int. Cl. E06C 7/12; B66F 3/24

(52) U.S. Cl. CPC E06C 7/12; B66F 3/247

(57) ABSTRACT

The present invention overcomes the disadvantages of the prior art by providing a pneumatic lift apparatus for a ladder. The apparatus is attachable to a conventional extendable ladder. The apparatus attaches to the lower end of the ladder and includes attachments for attaching the side rails of the ladder. A plate is attached in weight bearing relation between opposing pneumatic pistons which serve to lift the plate relative to the rails.

### BACKGROUND OF THE INVENTION

### 1. Field of the Invention

The present invention relates to ladders. More specifically, the invention relates to an improved pneumatic lifting apparatus for lifting a user and cargo.

### 2. Description of the Prior Art

Harvesting fruit from trees typically requires one to use a ladder or other means to reach the upper branches. As fruit tends to ripen at different times, a human picker is preferable to a machine harvester. Indeed, with fruit trees, the harvesting of a mechanical implement will tend to be far too damaging to the tree itself to be practical even with sophisticated robots.

Accordingly, one typically needs a ladder to access the branches higher up the tree to get to the fruit. The problem with the use of a ladder is that when descending the ladder to unload the fruit a worker can accidentally bruise or otherwise damage the fruit rendering it unsaleable at a grocery store as produce. Also, the weight of the picked fruit and the fact that it is suspended during descent creates a lot of off balance loading which can and often does result in falls.

Prior art attempts at ladder lift apparatuses have come with drawbacks. Most have chain or gear driven assemblies that are difficult or impossible to use in an orchard environment as the motivating assembly has a lot of exposed moving parts that can easily interfere with or accumulate plant debris or tree branches quickly rendering them unusable. Also, with chains and other mechanical linkages there is maintenance required.

The present invention overcomes the disadvantages of the prior art by providing a pneumatic lift apparatus for a ladder. The apparatus is attachable to a conventional extendable ladder, and may optionally be used in standalone mode. When attached to a ladder, the ladder provides additional structural support. The apparatus attaches to the side rails of the ladder and includes a vertically oriented frame having opposing primary frame members which act as guide rails for a trolley. A plate is attached in weight bearing relation between the opposing frame members and is motivated by a centrally disposed pneumatic piston which serves to lift the plate which is guided by opposing trolleys rollingly engaged within the frame members.

### SUMMARY OF THE INVENTION

It is a major object of the invention to provide a lift apparatus for a ladder.

It is another object of the invention to provide a pneumatic lift apparatus for a ladder having no chains or external linkage.

It is another object of the invention to provide a pneumatic lift apparatus for a ladder that can be attached to any extendable ladder or used in a standalone mode.

It is another object of the invention to provide a pneumatic lift apparatus for a ladder that is battery powered.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 shows a perspective view of the pneumatic ladder apparatus of the present invention.

FIG. 2 shows a front view of the pneumatic ladder apparatus of the present invention.

FIG. 3 shows a perspective view of a trolley used with the pneumatic ladder apparatus.

### DETAILED DESCRIPTION OF THE PREFERRED EMBODIMENTS

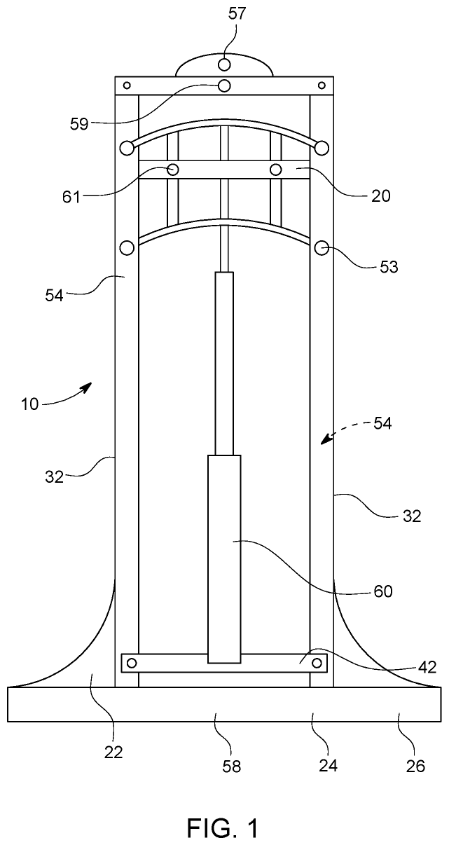

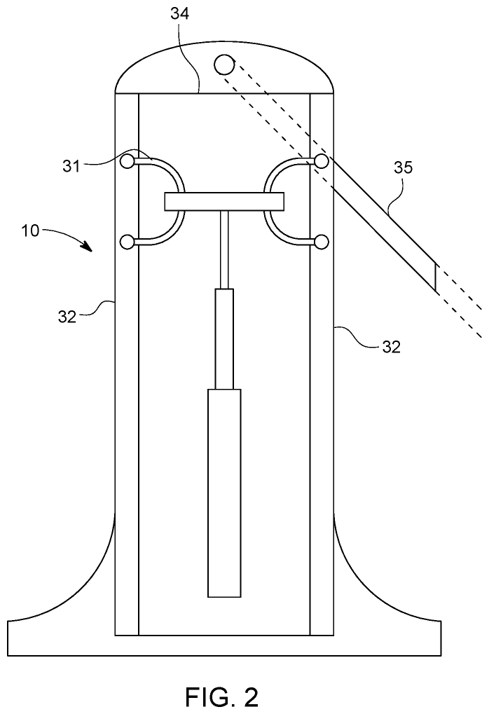

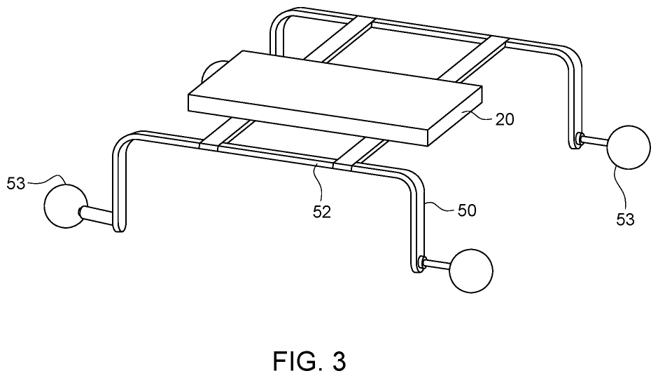

Referring now to FIGS. 1-3, the inventive apparatus, generally indicated by the numeral 10, is shown. The apparatus 10 is designed to provide a moving, vertically escalating, weight bearing footrest 20 upon which a user can stand. A key aspect of the invention is that the footrest 20 is not connected to the source of motive power by any external mechanical linkage other than a pneumatic piston. Also, the device maybe used with a ladder, the ladder providing additional stability to the apparatus 10.

The apparatus 10 has a base 22 which contains a pneumatic pump or compressor 24 and a battery 26. The battery 26 is rechargeable and the compressor 24 is electrically powered. Thus, the apparatus 10 is fully portable. In the event of a power outage the apparatus 10 cannot operate to raise the footrest 20, but can use a slow release of pneumatic pressure to lower the footrest 20 in a low power or no power scenario. It can be appreciated that this limited operational capability with no power is not possible using an electric motor.

Frame 31 extends from the base 22 and includes opposing side rails 32 which are connected to and extend upwardly from the base 22, the rails 32 connected at their respective top ends by a connecting cross arm 34, the arm having a kickstand 35 hingedly attached thereto. The kickstand 35 serves as vertical support when the apparatus 10 is used in standalone mode, that is, without the additional support and stability of the ladder.

The optional ladder 30 can be any standard sized extendable ladder, preferably made of metal. The side rails 33 of the ladder 30 can be attached to the apparatus 10 at spaced locations along the length by clamps or other fastening means as would be apparent to one of skill in the art. The base 22 of the apparatus 10 is relatively heavy from the weight of the compressor and battery 26 and is thus relatively stable. Spikes or stabilizing means such as traction pads may be used to provide additional stability to the apparatus 10.

Power for motivation of the footrest 20 is supplied by the compressor 24 via a pneumatic piston 60. The piston 60 is telescoping to allow for extension and retraction along a significant length of the apparatus 10, with the piston 60 fluidly coupled to compressor 24 and mechanically attached to the frame 31 of the apparatus by at least a stabilizing horizontal bar 42. The footrest 20 may be attached to piston 60 by fastening members 61 such as bolts and screws in the well known manner. Extension and retraction of the piston 60 effects raising and lowering of the footrest 20. Extension of the piston 60 is preferably limited to about ten feet as by a limiting micro-switch or other means apparent to one of skill in the art.

Attachment arms 50 are attached to a trolley 52 and extend from either side of the footrest 20, the footrest 20 attached to the trolley 52 as by welding. Wheels 53 are rollingly engaged within side rails 32, which have a channel 54 formed therein sized to receive the wheels.

The apparatus 10 is operated by push button controls 57, 59 one button 57 for up the other 59 for down. The pneumatic pump 24 and motor are preferably an integrated unit, and the apparatus 10 includes a reservoir 58 contained within the base 20. Preferably, the battery 24 can hold sufficient charge to power the apparatus for 10 hours.

In use, a user positions the apparatus 10 as desired near a work area. The kickstand 35 is then extended for additional stability in the absence of ladder 30 and the foot rest 20 may be raised or lowered as desired by the user. Ladder 30 may be used for additional stability especially on uneven ground.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

I claim:

1. A lift for an extendable ladder apparatus comprising:
a base, said base having a housing containing a compressor and an energy source for the compressor;
a frame extending vertically upward from said base and including a pair of opposing side rails;
a footrest positioned between and operatively connected to said siderails;
a pneumatic piston connected to receive pressurized air from said compressor with said footrest attached to said piston;
whereby said footrest can be raised and lowered between said siderails by movement of said piston.

2. The apparatus of claim 1 wherein said ladder is removably attached to said apparatus.

3. The apparatus of claim 1 wherein said footrest has a pair of connecting arms extending from opposing sides, said arms including rollers attached thereto.

4. The apparatus of claim 3 wherein said siderails have channels formed therein, and said rollers are rollingly disposed in said siderails.

5. The apparatus of claim 1 wherein said footrest is limited to about 10 feet of travel.

6. The apparatus of claim 1 wherein said footrest can be lowered in a no power situation.

7. The apparatus of claim 1 wherein said energy source is a battery.

8. The apparatus of claim 7 wherein said battery can provide about 10 hours of operational power.
